(19) United States
(12) Patent Application Publication
(10) Pub. No.: US 2022/0289293 A1
(43) Pub. Date: Sep. 15, 2022

(54) VISUALISATION AID FOR A VEHICLE

(71) Applicant: Daniel TUROK, Romsey, VIC (AU)

(72) Inventor: Daniel TUROK, Romsey, VIC (AU)

(21) Appl. No.: 17/636,441

(22) PCT Filed: Aug. 3, 2020
(86) PCT No.: PCT/AU2020/050794

§ 371 Date: Feb. 18, 2022

(30) Foreign Application Priority Data
Aug. 20, 2019 (AU) 2019903036

(51) Int. Cl. B62D 15/02; B60W 50/14; B60K 35/00

(52) U.S. Cl. CPC B62D 15/025; B62D 15/0295; B60W 50/14; B60K 35/00; B60W 2050/146; B60K 2370/1529; B60K 2370/171; B60K 2370/177; B60K 2370/31; B60K 2370/334; B60K 2370/193

(57) ABSTRACT

The present invention is directed to a visualisation aid for indicating to a driver of a vehicle a projected location of a front wheel (90A, 90B) of the vehicle on a ground surface, the visualisation aid including an indicator (10A, 10B), wherein: the indicator is positionable in the line of sight (5A, 5B) of the driver looking out of the vehicle at the ground surface, the indicator is positionable at or above a boundary (140) of the vehicle in the light of sight, and the line of sight (5A, 5B) beyond the boundary of the vehicle intersects with an imaginary vertical plane (7A, 7B) extending forward from the front wheel of the vehicle (90A, 90B).

### TECHNICAL FIELD

The invention relates to a visualisation aid for a vehicle, and in particular, the invention relates to a visualisation aid for road vehicles such as cars, trucks and buses.

### RELATED APPLICATION

This application claims priority to Australian provisional patent application no. 2019903036 filed 20 Aug. 2019 and entitled “VISUALISATION AID FOR A VEHICLE”, and incorporates by reference the entire contents of that Australian provisional application.

### BACKGROUND ART

Vehicles, and road vehicles in particular, are inherently dangerous machines. They can travel at great speeds, are regularly driven in busy or difficult driving conditions, and despite having a variety of safety systems built into the vehicles (often government mandated), small lapses or miscalculations by drivers can have dramatic consequences including serious injury to drivers, passengers, other road users or pedestrians, and can come with significant cost (e.g. to repair damage to a vehicle, medical related costs, etc.).

Sometimes, it can be difficult for a driver to correctly judge the location of wheels of the vehicle that they are driving, or the part of the road or the path that the vehicle is likely to travel on a road, other ground surface or other surface. This may be due to a number of factors, some relating to the driver, some to the car and others to the driving environment. For example, some drivers may be particularly poor at judging distances or dimensions; some vehicles may be shaped or sized such that there is a significant distance between the eyes of the driver and the vehicle wheels, or the geometry of the vehicle makes it difficult for a driver to judge the vehicle wheel location, a projected wheel location, or a wheel path; or visibility of the road surface is limited. In some circumstances, a driver may be used to driving a vehicle from the left side of the vehicle (or the right side of the vehicle) and based on that experience have a spatial awareness that makes it difficult to accurately assess the geometry of a vehicle (and in particular, vehicle wheel location) where they are removed from their habitual driving conditions and driving from the opposite side of the vehicle (e.g. when driving in a foreign country).

Sometimes, it can be particularly important for a driver to know the location of wheels of the vehicle or the road or other ground surface that the wheels will traverse, such as where the ground surface is narrow (e.g. around the edge of a mountain), where there are irregularities in the road surface (e.g. large potholes) or other obstacles on the ground which the driver wants to avoid. At other times, it may be important for the wheels to be aligned with thin sections of a ramp which may be not much wider than the width of the wheel itself (e.g. where a vehicle is being loaded onto another vehicle for transport). And more generally, it is important for drivers to ensure that they keep their vehicle within lane markings, for obvious reasons including so as not to collide with other vehicles. Keeping a vehicle within lane markings may be particularly difficult in conditions where temporary lane markings are applied during road works, as such temporary markings may be unclear or otherwise difficult to follow due to a driver's lack of familiarity with the temporary traffic arrangements.

Existing devices such as curb feelers comprising springs or wires installed on a vehicle operate to alert divers by sound or by an impact force that the feeler has impacted a curb. These devices are useful when it comes to sensing curbs, however, they are limited to providing driver feedback in relation to curbs only and are not suited for assisting the driver to manage other road surface features (e.g. pot-holes) or ensure that the wheel of the vehicle traverses a specific section of ground or other surface.

Other more elaborate devices have been conceived to assist a driver including a camera or other optical sensors to relay images to the driver of a vehicle wheel and the ground surface adjacent to the wheel, the images being presented to the driver using a monitor. These devices can be distracting for a driver as they take the driver's vision away from the ground surface (or objects on the ground surface) in front of the vehicle and can be distracting, and problematic due to the inclusion of a digital monitor (which can be bulky, and difficult to integrally retrofit into a dashboard).

Other difficulties with existing devices include one or more of the following:
a. Due to limited space directly in front of the wheel, it is not easy to obtain images of the wheel and the ground surface the wheel will traverse using a single camera or other sensor
b. In order to depict a travel path of a vehicle wheel, multiple sensors or other means may be required to project the location of the wheel on earlier images taken of ground surface
c. There may be a need to generate a composite image that combines images taken by multiple sensors

Therefore, existing devices have been lacking in one or more of the following respects, including but not limited to:
a. Providing limited assistance to the driver to determine the location of a vehicle wheel, projected wheel location, or the path that the vehicle wheel will take on a surface. More particularly, limited assistance is provided by the prior art for drivers on a variety of different road or other surfaces;
b. Distracting the driver and taking their attention away from the surface (or object on the surface) that the vehicle is traversing;
c. Providing a driver unnecessary visual information which distracts from driving;
d. The requirement for (as opposed to optionality of) multiple sensors and/or image processing (or other more elaborate equipment or processes) to counteract the limited space for locating sensors close to the wheel and difficulty in obtaining desired image;
e. An elaborate combination of components to deliver the desired result; and/or
f. Difficulty retrofitting to existing vehicles.

It is to be understood that, if any prior art information is referred to herein, such reference does not constitute an admission that the information forms part of the common general knowledge in the art, in Australia or any other country.

### SUMMARY OF THE INVENTION

The present invention arises from a recognition that improvements in driver awareness of wheel location and/or wheel path can be achieved by a driver aid which addresses one or more of the shortcomings of the prior art, or at least provides useful alternative thereto.

### Solution to Problem

According to a first aspect of the invention, there is provided a visualisation aid for indicating to a driver of a vehicle the projected location of a front wheel of the vehicle on a ground surface, the visualisation aid including an indicator, wherein: the indicator is positionable in the line of sight of the driver looking out of the vehicle at the ground surface; the indicator being positionable at, near or above a boundary of the vehicle, in or near to the light of sight; and the line of sight beyond the boundary of the vehicle intersects with an imaginary vertical plane extending from the front wheel of the vehicle.

Preferably, the indicator is positionable at the boundary of the vehicle in the line of sight of the driver. It is further preferred that the indicator is positionable in the line of sight of the driver looking out of a front windscreen of the vehicle.

The boundary of the vehicle in the line of sight of the driver may include, inter alia, the edge of a dashboard, part of the front bonnet of the vehicle, or an accessory attached to a front section of the vehicle, such as a bull bar, or any other perimeter of the vehicle including a vehicle attachment or accessory visible to the driver in the seated position and in the line of sight of the driver looking out of the front windscreen at a ground surface.

It is preferred that the width of the imaginary vertical plane is defined by the width of the front wheel. It is particularly preferred that the imaginary vertical plane extends forward from the front wheel of the vehicle.

Preferably, the visualisation aid is configured to set a target position for the indicator, the target position being determined by having reference to one or more, or any combination of, factors including the following: driver height; the shape or configuration of the boundary of the vehicle which is visible to the driver; driver seat height; angle of inclination of the backrest of the driver seat; driver eye position; driver perspective bias; vehicle dimensions; vehicle wheel size; vehicle front wheel orientation; steering wheel orientation; ground surface inclination; other properties of the ground surface; and/or the relative location of the wheel to the driver.

Preferably, the visualisation aid includes means for the indicator to be automatically positioned at or close to the target position by applying one or more of the factors to position the indicator.

It is preferred that the indicator is automatically adjustable in response to contemporaneous driving parameters including any one or more of, or any combination of, the following parameters: the position of the driver's eyes; vehicle speed or acceleration; the position of the driver's seat; driving conditions; ground surface inclination; other properties of the ground surface; front wheel orientation; and/or steering wheel orientation.

The visualisation aid preferably includes one or more of, or a combination of, the following sensors for providing sensor data: a driver eye location sensor; a vehicle speedometer and/or accelerometer; a steering wheel orientation sensor; a front wheel orientation sensor; a seat height and/or back rest inclination sensor; and/or a sensor for detection of a hazardous object on the ground or surface; and means for receiving sensor data from one or more of, or a combination of the sensors.

The visualisation aid, in a preferred form, includes a sensor for sensing driving conditions including properties of the ground surface or other driving conditions for which the visualisation aid is adapted to assist the driver; the visualisation aid further being adapted to be automatically activated or deactivated in response to, or automatically adapt its position and/or visual form to, said sensed driving conditions.

Preferably, the indicator is configured such that the driver is able to view the ground surface through and/or around the indicator.

The indicator is preferably adapted to indicate to the driver a change in an orientation of the front wheel and/or the projected wheel location by a corresponding change in the orientation of the indicator as viewed by the driver.

Preferably, the visualisation aid is adapted to indicate to the driver a projected vehicle wheel path comprising an extended section of ground surface that the vehicle front wheel is likely to traverse. In a preferred form, the indicator indicates the projected vehicle wheel path by providing the driver an unimpeded or substantially unimpeded view of the ground surface through and/or around the indicator. Preferably, indication of the vehicle projected wheel path is provided by enabling the driver to extrapolate the vehicle wheel path based on the orientation of the indicator against the ground surface.

In a particularly preferred form, the visualisation aid is adapted to indicate a change in the projected vehicle wheel path through rotation or other movement of the indicator, wherein that rotation or movement of the indicator is responsive to the orientation of the steering wheel.

Preferably, the visualisation aid is able to be retrofit to an existing vehicle.

In a preferred form, the indicator comprises an indicator body. Preferably, the indicator body is positionable forward of a front windscreen of the vehicle.

The visualisation aid preferably includes a connector for connecting the indicator body to the vehicle. Preferably, the connector includes a thin elongate element. In a preferred form, the connector is collapsible. In a particularly preferred form, the connector and/or indicator body is able to rotate, pivot or otherwise move relative to the vehicle.

Preferably, the visualisation aid is movable from an operative position to an inoperative position. It is preferred that when the visualisation aid is in an operative position, the connector is substantially perpendicular to the ground or other surface.

Preferably, the indicator body includes an open central section through which the ground or other surface is viewable by the driver, the open section being flanked or surrounded by a peripheral portion. In a preferred form, the peripheral portion includes one or more elements consisting of one or more, or any combination of, the following: a ‘V’ shaped element; an ‘O’ shaped element; an arrow shaped element; and/or a frusto-conical shaped element. In a particularly preferred form, the peripheral portion is rounded and axially symmetric.

In a preferred form, the indicator comprises an indicator display.

In a preferred form, the indicator display comprises an image on a screen such that the indicator display appears on the screen at or near the intersection of the screen and the line of sight of the driver. In a particularly preferred form, the indicator display comprises an image on a front windscreen of the vehicle. In a further particularly preferred form, the indicator display comprises an image on a screen that is mountable to the interior of the vehicle.

Preferably, a projected vehicle wheel path able to be indicated to the driver by displaying a wheel path on the screen, the displayed wheel path comprising an image indicating an extended section of ground surface that the vehicle front wheel is likely to traverse.

In a preferred form, the indicator display is displayable on or near a dashboard of the vehicle.

It is preferred that the indicator display, or a part of the indicator display, is translucent, or substantially translucent.

Preferably, the visualisation aid includes an integrated car heads up display unit.

It is preferred that the location of the front wheel is indirectly indicated to the driver solely by the position of the indicator.

The visualisation aid may include a first and a second indicator for indicating to the driver the projected location of a first front wheel of the vehicle, and the projected location of a second front wheel of the vehicle, respectively.

According to a second aspect of the invention, there is provided a visualisation aid for assisting a driver of a vehicle, the visualisation aid including an indicator and a connector for connecting the indicator to the vehicle, the indicator being positionable in the line of sight of the driver looking at a ground or other surface from a seated position within the vehicle, wherein the indicator is adapted to indicate to the driver the location and/or orientation of a wheel of the vehicle.

Preferably, the indicator is positionable forward of a front windscreen of the vehicle. Preferably, the indicator is positionable in the line of sight of the driver looking at the ground or other surface through the front windscreen of the vehicle.

Preferably, the driver in a seated position includes a driver sitting in the driver's seat of the vehicle.

The indicator is preferably adapted to indicate to the driver a vehicle wheel path.

Preferably, indication of the vehicle wheel path includes indicating a section of ground or other surface that the vehicle wheel is likely to traverse.

Preferably, the indicator indicates the vehicle wheel path by providing the driver an unimpeded or substantially unimpeded view of the ground surface through and/or around the indicator.

Preferably, the maximum width of the indicator is equivalent to the width of an average wheel seen by the driver on a substantially flat ground surface (or other surface) in the line of sight of the driver as he/she looks over the bonnet or other boundary of the vehicle. Preferably, the maximum width of the indicator is between about 20 mm and about 40 mm; more particularly, the maximum width of the indicator is between about 25 mm and about 35 mm; in a particularly preferred form the width of the indicator is about 30 mm.

Preferably, the connector includes an elongate element. Preferably, the elongate element is thin. Preferably, the maximum width of the elongate element is less than the indicator. Preferably, the connector is less than 12 mm in width.

In a preferred form, the elongate element includes or comprises a rod.

In a preferred form, the connector is collapsible. In a particularly preferred form, the connector includes a plurality of telescoping portions.

Preferably, the indicator is positionable at, or near, an upper part of the elongate element.

Preferably, the indicator and/or connector includes a light source. The light source may be a LED light. Preferably, the light source is powered by the vehicle battery. Alternatively, the light source may be powered by a battery located on or near the visualisation aid.

In a preferred form, the indicator and/or connector includes a glow-in-the-dark compound for enhanced visibility. The glow-in-the-dark compound may include one or more of, or a combination of, phosphorus, zinc sulphide or strontium aluminate.

It is preferred that the indicator is positionable at or near the boundary of the vehicle which is visible to the driver. Preferably, in use, part of the boundary of the vehicle is visible to the driver directly below the lower part of the indicator as viewed by the driver.

The visible boundary of the vehicle may depend on a driver's seating preferences (e.g. how much they raise the driver's seat), characteristics of the driver (e.g. driver's height) and/or the driver's preferred angle for viewing the road. The boundary of the vehicle may also depend on the form of the vehicle itself. The boundary of the vehicle visible to the driver may be an interior part of the vehicle, such as the dash board, or an exterior part of the vehicle (e.g. the front bonnet of car).

Preferably, in use, there is a gap between the lower part of the indicator and the part of the boundary of the vehicle which is visible to the driver, or a gap through the indicator itself, such that the driver is able to view the ground or other surface visible to the driver through said gap.

Preferably, the ability to view the ground or other surface visible to the driver through said, enables indication to the driver of the vehicle wheel path.

Preferably, the visualisation aid is adapted to provide the driver an indication of the location of the vehicle wheel by being positionable above the wheel in a position that counteracts perspective bias of the driver due to sitting towards a left or right side of the vehicle.

Preferably, the indicator location is adjustable to provide assistance to drivers having different degrees of perspective bias.

Preferably, indication of the vehicle wheel location is provided by the indicator being positionable in or around the vertical plane extending along the imaginary line of sight between the driver and the wheel, beyond the actual wheel location.

Preferably, a target position for the indicator is determined by having reference to one or more factors including the following: driver height; the shape or configuration of the boundary of the vehicle which is visible to the driver; driver seat height; angle of inclination of the backrest of the driver seat; driver perspective bias; vehicle dimensions; vehicle wheel size; and/or the relative location of the wheel to the driver.

Preferably, the target position for the indicator provides that part of the boundary of the vehicle is visible to the driver directly below the lower part of the indicator as viewed by the driver.

Preferably, the target position provides a gap between the lower part of the indicator and the part of the boundary of the vehicle, or a gap through the indicator itself, which is visible to the driver, such that the driver is able to view the ground or other surface visible to the driver through said gap. Preferably, the ability to view the ground or other surface visible to the driver through said gap, enables indication to the driver of the vehicle wheel path.

Preferably, the target position operates to provide the driver an indication of the location of the vehicle wheel. Preferably, indication of the vehicle wheel location is provided by the indicator being positionable such that the vehicle wheel is located in or around the vertical plane extending along the imaginary line of sight between the driver and the indicator, beyond the actual wheel location.

In a preferred form, the visualisation aid provides means for the indicator to be automatically positioned at or close to the target position by applying one or more of the factors to position the indicator.

In a further preferred form, the position of the indicator is able to be manually positioned at or close to the target position.

Preferably, the visualisation aid provides for automatic and manual positioning.

Preferably, the visualisation aid is movable from an operative position to an inoperative position. It is preferred that, in the operative position, the connector is substantially perpendicular to a bonnet of the vehicle (as viewed by the driver). Alternatively, the connector may extend at an obtuse or acute angle with respect to the bonnet of the vehicle in the operative position (as viewed by the driver); this may be relevant where the vehicle is turning.

In a preferred form, in the inoperative position, the connector not visible to the driver when in a driving position. In a preferred form, the connector in the inoperative position is substantially parallel to the bonnet of the vehicle (as viewed by the driver).

Preferably, the visualisation aid is remotely moveable from the operative position to the inoperative position by the driver from within the vehicle.

Preferably, the visualisation aid is automatically moveable from the operative position to the inoperative position.

Preferably, the visualisation aid is adapted to be automatically moved to an operative position in response to driving conditions such as where there is an obstacle on the road or non-uniformity in the road surface.

The indicator may include a peripheral portion.

Preferably, the peripheral portion is adapted to indicate the orientation of the vehicle wheel (e.g. relative to the principal horizontal axis of the vehicle).

The peripheral portion may include one or more elements. The peripheral portion of the indicator may include a ‘V’ shaped element. The peripheral portion of the indicator may include an ‘O’ shaped element. The peripheral portion of the indicator may include an arrow shaped element. The peripheral portion of the indicator may include a frusto-conical element.

The peripheral portion of the indicator may be rounded. The peripheral portion of the indicator may be axially symmetric. In a preferred form, the indicator is rounded and axially symmetric such that it appears to have the same geometry when viewed at different angles by the driver.

Preferably, the indicator includes an open central section through which the ground or other surface is viewable by the driver. The open central section may be flanked by the peripheral portion.

Preferably, the indicator, or a part of the indicator, is transparent or translucent.

Preferably, the indicated wheel path is responsive to the contemporaneous driving parameters.

Preferably the connector is able to rotate, pivot or otherwise move relative to the vehicle. Preferably, such movement is responsive to contemporaneous driving parameters. Preferably, the indicator is able to rotate, pivot or otherwise move relative to the vehicle. Preferably, such movement is responsive to contemporaneous driving parameters.

In a preferred form, the indicator is automatically adjusted in response to contemporaneous driving parameters including any one or more of, or any combination of the following parameters: the position of the driver's eyes; vehicle speed or acceleration; the position of the driver's seat; driving conditions (e.g. such the presence or absence of an obstacle on the road or change in uniformity in the driving surface sensed by the visualisation aid); and/or steering wheel orientation.

Preferably, indication of the vehicle wheel path is provided by enabling the driver to extrapolate the vehicle wheel path based on the orientation of the indicator against the ground or other surface in the background. Preferably, the indicator includes an arrow or lines or similar markings to assist in the indication of the vehicle wheel path to the driver.

It is preferred that the indicator is adapted to indicate to the driver the vehicle wheel path if the driver steers the vehicle in a straight line or a substantially straight line.

Preferably, the indicator is adapted to indicate to the driver the vehicle wheel path if the driver steers the vehicle to perform a turn. Preferably, the indicator is adapted to rotate with respect to the driver or vehicle and/or move with respect to the driver or vehicle, as the steering wheel is turned to assist in the indicating the vehicle wheel path to the driver.

In a preferred form, the visualisation aid is adapted to indicate the orientation of a wheel through rotation of the indicator relative to the connector, wherein rotation of the indicator is responsive to the orientation of the steering wheel.

Preferably, the visualisation aid includes one or more of, or a combination of, the following sensors for providing sensor data: a driver eye location sensor; a vehicle speedometer or accelerometer; steering wheel orientation sensor and/or seat height and/or back rest inclination sensor; a sensor for detection of a hazardous object on the ground or surface; a sensor for detection of a surface or other driving condition for which the visualisation aid is adapted to assist the driver.

Preferably, the visualisation aid includes means for receiving sensor data from one or more of, or a combination of the sensors.

Preferably, the visualisation aid includes a processing device for processing sensor data corresponding to contemporaneous driving parameters to determine the movement and/or position of the indicator in response to those contemporaneous driving parameters and/or the target position.

Preferably, the indicator is adapted to be automatically activated or deactivated in response to, or automatically adapt its location and/or visual form to, sensed driving conditions (e.g. such the presence or absence of an obstacle on the road or change in uniformity in the driving surface sensed by the visualisation aid).

According to a third aspect of the invention there is provided a visualisation aid for assisting a driver of a vehicle, the visualisation aid including an indicator display comprising a visually projectable indicator, the visually projectable indicator being projectable onto a screen in the line of sight of the driver looking at a ground or other surface through the screen, wherein the visually projectable indicator is adapted to indicate to the driver the location and/or orientation of a wheel.

Preferably, the visually projectable indicator is adapted to indicate to the driver a vehicle wheel path.

Preferably, indication of the vehicle wheel path includes indicating a section of ground or other surface that the vehicle wheel is likely to traverse.

Preferably, the visually projectable indicator indicates the vehicle wheel path by means which provides the driver an unimpeded or substantially unimpeded view of the ground surface through and/or around the indicator.

The visually projectable indicator may include a peripheral portion.

Preferably, the peripheral portion of the visually projectable indicator is adapted to indicate the orientation of the vehicle wheel (e.g. relative to the principal horizontal axis of the vehicle).

The peripheral portion may include one or more elements. The peripheral portion of the indicator may include a ‘V’ shaped element. The peripheral portion of the visually projectable indicator may include an ‘O’ shaped element. The peripheral portion of the visually projectable indicator may include an arrow shaped element. The peripheral portion of the visually projectable indicator may include a 2 dimensional projection of a frusto-conical element.

The peripheral portion of the indicator may be rounded. The peripheral portion of the indicator may be axially symmetric.

Preferably, the visually projectable indicator includes an open central section through which the ground or other surface is viewable by the driver. The open central section may be flanked by the peripheral portion.

Preferably, the visually projectable indicator, or a part of the visually projectable indicator, is transparent or translucent.

Preferably, the visually projectable indicator is projectable onto a front windscreen of the vehicle in the line of sight of the driver looking at the ground or other surface through the front windscreen of the vehicle. Alternatively, or in addition, the visually projectable indicator may be projectable onto a screen which is mountable to the interior of the vehicle in the line of sight of the driver looking at the ground or other surface through the front windscreen of the vehicle. Preferably, the screen is mountable on the upper part of the dashboard of the vehicle.

In a preferred form, the wheel path is indicated to the driver by projecting the path of wheel travel on the windscreen or other screen in the light of sight of the driver.

Preferably, in use, the driver is able to view the ground or other surface through and/or around the visually projectable indicator to enable indication to the driver of the vehicle wheel path.

Preferably, the visually projectable indicator is adapted to provide the driver an indication of the location of the vehicle wheel by being positionable in a position that counteracts perspective bias of the driver due to sitting towards a left or right side of the vehicle.

Preferably, the indicator location is adjustable to provide assistance to drivers having different degrees of perspective bias.

Preferably, indication of the vehicle wheel location is provided by the indicator being positionable in or around the vertical plane extending along the imaginary line of sight between the driver and the wheel, at the location where said vertical plane intersect with the screen.

Preferably, a target position for projection of the visually projectable indicator is determined by having reference to one or more factors including the following: driver height; the shape or configuration of the boundary of the vehicle which is visible to the driver; driver seat height; angle of inclination of the backrest of the driver seat; driver perspective bias; vehicle dimensions; vehicle wheel size; and/or the relative location of the wheel to the driver.

Preferably, the target position for the indicator provides a for the ability to view the ground or other surface visible to the driver through or around the indicator, enabling indication to the driver of the vehicle wheel path.

Preferably, the target position operates to provide the driver an indication of the location of the vehicle wheel. Preferably, indication of the vehicle wheel location is provided by the indicator being positionable such that the vehicle wheel is located in or around the vertical plane extending along the imaginary line of sight between the driver and the indicator, at the location where said vertical plane intersect with the screen.

In a preferred form, the visualisation aid provides means for the indicator to be automatically projected onto or near the target position by applying one or more of the factors to position the indicator.

In a further preferred form, the projection (including its position) is able to be manually positioned at or close to the target position.

Preferably, the location and/or visual form of the visually projectable indicator is adapted to respond to a plurality of factors including one or more of, or a combination of, the following: driver height; the shape or configuration of the boundary of the vehicle which is visible to the driver; seat height; the size or location of the screen onto which the visually projectable indicator is projectable; angle of inclination of the backrest of the seat; vehicle dimensions; wheel size; and/or the relative location of the wheel to the driver.

Preferably, the visually projectable indicator is adapted to automatically respond to the plurality of factors.

It is preferred that the position and/or visual form of the visually projectable indicator is manually controlled by the driver.

Preferably, indication of the vehicle wheel path is provided by enabling the driver to see and/or extrapolate the vehicle wheel path based on the orientation of the indicator against the ground or other surface in the background. Preferably, the indicator includes an arrow or lines or similar markings to assist in the indication of the vehicle wheel path to the driver.

Preferably, the visually projectable indicator is adapted to indicate to the driver the vehicle wheel path that will be taken if the driver steers the vehicle in a straight line or a substantially straight line.

Preferably, the visually projectable indicator is adapted to indicate to the driver the vehicle wheel path that will be taken if the driver steers the vehicle to perform a turn. Preferably, the indicator is adapted to adjust as the steering wheel is turned to assist in the indicating the vehicle wheel path to the driver.

In a preferred form, the location and/or visual form of the visually projectable indicator is adapted to respond to contemporaneous driving parameters including any one or more of, or any combination of the following parameters: the position of the driver's eyes; vehicle speed or acceleration; the position of the driver's seat; driving conditions; driving conditions (e.g. such the presence or absence of an obstacle on the road or change in uniformity in the driving surface sensed by the visualisation aid); and/or steering wheel orientation.

The visualisation aid may include one or more of, or a combination of the following sensors for providing sensor data: driver eye location sensor; vehicle speedometer or accelerometer; steering wheel orientation sensor; seat height and/or back rest inclination sensor; a sensor for detecting a hazardous object on the ground or surface; a sensor for detection of a surface or other driving condition for which the visualisation aid is adapted to assist the driver.

Preferably, the visualisation aid includes means for receiving sensor data from one or more of, or a combination of the sensors.

Preferably, the visualisation aid includes a processing device for processing sensor data corresponding to contemporaneous driving parameters to determine the movement and/or position of the visually projectable indicator in response to the contemporaneous driving parameters.

Preferably, the visually projectable indicator is adapted to be automatically activated or deactivated in response to, or automatically adapt its location and/or visual form to, sensed driving conditions.

Preferably, the visually projectable indicator is adapted so that the driver is able activate or deactivate the projection of the indicator.

In a preferred form, the visually projectable indicator is adapted to indicate the orientation of a vehicle wheel wherein the projection indicating wheel orientation is responsive to the orientation of the steering wheel.

In a preferred form, the visualisation aid of the third aspect of the invention (i.e. including a visually projectable indicator) is adapted to be included in an integrated car heads up display unit.

The visualisation aid of the invention may be adapted to be provided in an arrangement where it is integrated with vehicle.

The visualisation aid of the invention is preferably adapted to be retrofit to an existing vehicle.

Preferably, in retrofit form, the visualisation aid, or a part of the visualisation aid, including an indicator display or visually projectable indicator, is able to be attached to the dashboard of the vehicle. In a particularly preferred form, the retrofit visualisation aid is removably attachable to the dashboard of the vehicle, or around the dashboard of the vehicle.

The features described in relation to one or more aspects of the invention are to be understood as applicable to other aspects of the invention.

Other aspects of the invention are also disclosed.

### Advantageous Effects of Invention

Many advantages are achieved by the present invention, many of which will be well appreciated by a skilled person—and some of which are outlined below.

Benefits of the invention include one or more of:
a. Ease of use
b. Cost effective, particularly in the most basic forms of the invention
c. Preserves visual continuity during driving as driver's direct view of the ground or other surface is not obstructed
d. Provides improved safety by assisting drivers to negotiate ground or other surfaces, and/or hazardous objects located on the ground or other surfaces
e. Assists the driver to determine wheel placement when driving on uneven terrain including rocks, ruts or other foreign objects such as logs or trees on the ground
f. Assists in reducing vehicular damage
g. Enables drivers to negotiate confined environments such as narrow bridges or other scenarios requiring more precise attention to the road conditions, such as two way roads where temporary bollards are placed

### BRIEF DESCRIPTION OF DRAWINGS

FIG. 1 is a schematic drawing representing the difference between perceived and actual wheel location.

FIG. 2 is a schematic drawing of a visualisation aid according to a first preferred embodiment of the present invention.

FIG. 3 is a schematic drawing of a visualisation aid according to a second preferred embodiment of the present invention.

FIG. 4 is a schematic drawing of a visualisation aid according to a third preferred embodiment of the present invention.

FIG. 5 is a schematic drawing of a visualisation aid according to a fourth preferred embodiment of the present invention.

FIG. 6 is a schematic drawing illustrating an implementation of the first preferred embodiment of the visualisation aid.

FIG. 7 is a schematic drawing illustrating an implementation of a visualisation aid according to fifth preferred embodiment of the invention and comprising an indicator display, in a first driving scenario.

FIG. 8 is a schematic drawing illustrating an implementation of the visualisation aid according to a sixth preferred embodiment of the invention and comprising an indicator display, in a second driving scenario.

FIG. 9 is a schematic drawing of a visualisation aid according to a seventh preferred embodiment of the invention.

FIG. 10 is a schematic drawing of a visualisation aid according to an eighth preferred embodiment of the invention.

FIG. 11 is a schematic drawing of a visualisation aid according to a ninth preferred embodiment of the invention.

### DESCRIPTION OF EMBODIMENTS

The structure, principle and operation of the described visualisation aid is provided below, as will be appreciated by those skilled in the art.

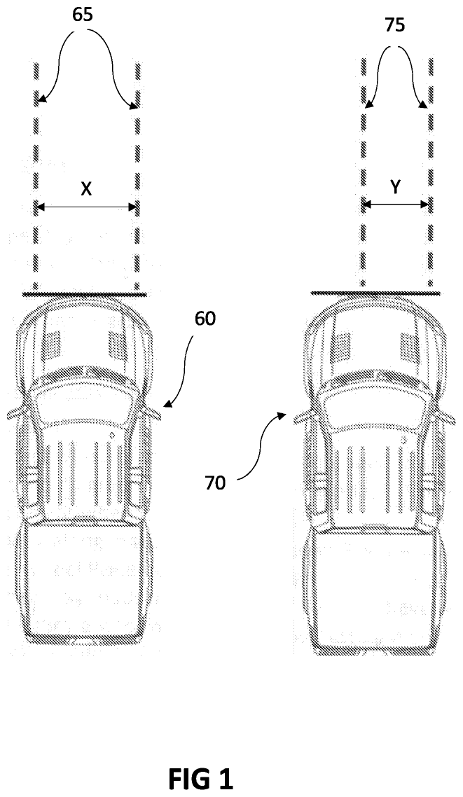

FIG. 1 illustrates the perspective bias that a right side driver of a vehicle experiences. In the vehicle 60 on the left, there are shown two actual vehicle wheel paths 65 that extend in vertically in line with the location of the left and right wheels of the vehicle (not visible). In this scenario, it is assumed that the vehicle wheels are aligned such that each of the cars 65, 70 would travel in a straight line.

In the vehicle 70 on the right, the two vehicle wheel paths 75 indicate the driver perceived wheel path. The two perceived wheel paths 75 are separated by a distance, Y, whereas the two actual wheel paths 65 are separated by a distance X, where X is greater than Y. It will be apparent that the left wheel path of the perceived vehicle wheel paths 75 is closer to the centre of the vehicle compared to the left wheel path of the actual vehicle wheel paths 65, and for the reasons set out earlier in this specification, this can create a number of problems.

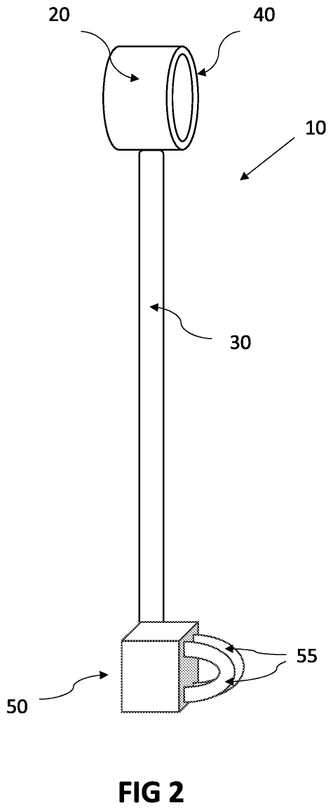

FIGS. 2 to 5 depict visualisation aids 10, 11, 12 and 13, each visualisation aid for assisting a driver of a vehicle by indicating to the driver the location and/or orientation of a wheel of the vehicle. Each of the visualisation aids 10, 11, 12, 13 include a respective peripheral portion 40, 41, 42, 43.

FIG. 2 depicts visualisation aid 10, the visualisation aid including an indicator 20 comprising a tubular section in the shape of an “0” and a connector 30 comprising a rod for indirectly connecting the indicator 20 to the vehicle. The indicator 20 includes an open central section (flanked by peripheral portion 40) through which ground or other surface is viewable by the driver.

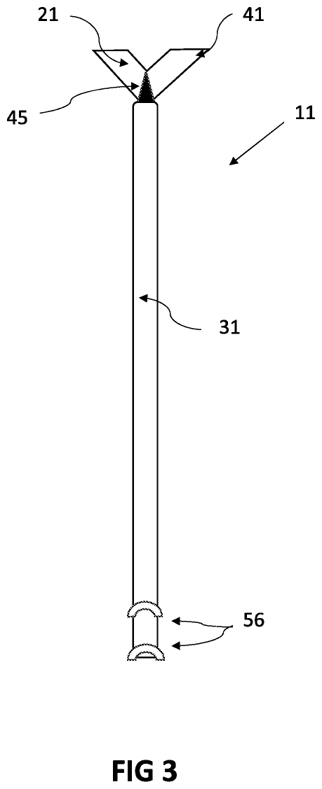

FIG. 3 depicts visualisation aid 11, the visualisation aid including an indicator 21 comprising a “V” shaped element and a connector 31 comprising a rod for indirectly connecting the indicator 21 to the vehicle. The indicator 22 includes an open central section (flanked by peripheral portion 42) through which ground or other surface is viewable by the driver. The indicator 21 includes an arrow marking 45 to assist in the indication of the vehicle wheel path to the driver. The interior of the “V” shaped segment (excluding he arrow), is transparent such that the peripheral portion 42 forms a boundary through which the driver may view the ground or other surface.

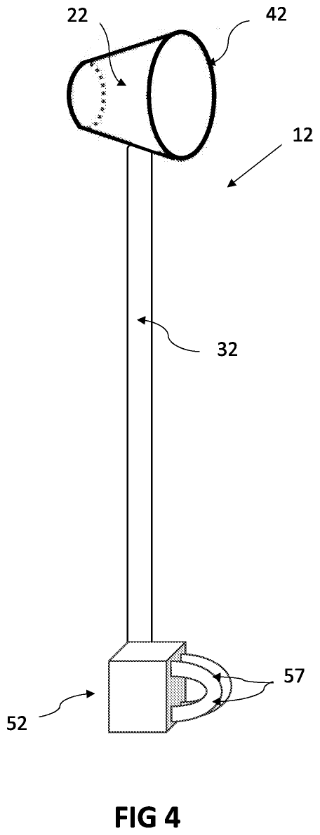

FIG. 4 depicts visualisation aid 12, the visualisation aid including an indicator 22 comprising a frusto conical thin tubular section and a connector 32 comprising a rod for indirectly connecting the indicator 22 to the vehicle. The indicator 22 includes an open central section (flanked by peripheral portion 42) through which ground or other surface is viewable by the driver.

With reference to FIGS. 2 to 5, each of the visualisation aids 10, 11, 12, 13 may be manually positioned at or close to a target position where each of indicators 20, 21, 22, 23 is located a little distance above the boundary of the vehicle (not shown) that is visible to the driver in use. The driver may therefore observe the ground surface around the indicator 20, 21, 22, 23 to assist in determining the vehicle wheel path.

Each of the indicators 20, 21, 22 are able to rotate relative to the connector by rotation means (not shown) located with the bodies of the respective connectors and indicators, wherein rotation of indicator is response to rotation of the vehicle steering wheel, to provide a visual indication to the driver of the orientation of the vehicle wheel.

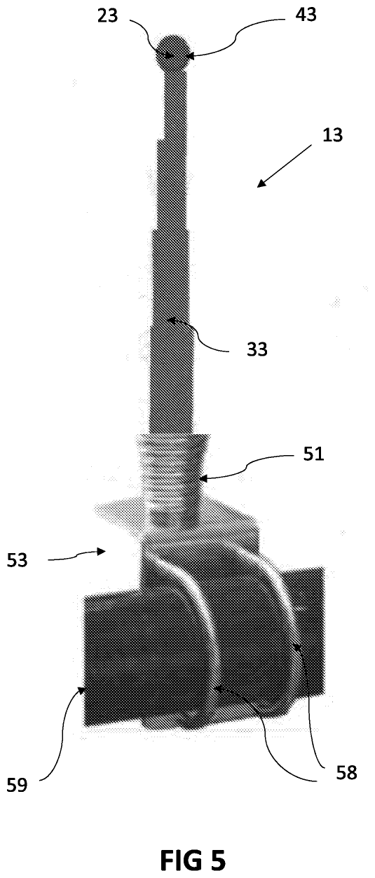

The visualisation aid represented in FIG. 5 includes an automatically telescoping connector 33, the connector being responsive to sensors in the vehicle that sense the eyeline of the driver including by reference to the driver seat position or driver height, and raise and lower the telescoping portions of the connector 33 accordingly so that the indicator 23 remains at or close to the target position. The indicator 23 is rounded and axially symmetric, and includes an LED light which when activated (e.g. in certain driving conditions such as wet weather) provides a stronger contrast to the background viewed by the driver. The LED light is powered by the vehicle battery. The strength of the LED light source can be adjusted based on driver preference and/or driving conditions.

FIG. 5 also includes a spring attachment 51 for attaching the connector 33 to the fixing means 53 for fixing the visualisation aid 13 to the vehicle. The spring attachment 51 provides for increased resilience of the visualisation aid 13 as it permits pivoting of the connector relative to the fixing means (e.g. to absorb any forces which impact the connector 33 or indicator 13 and thereby minimise damage to those components). Fixing means 53 includes wrap around hooks 58 that fix the visualisation aid 13 to a vehicle via a section of the bull bar 59 of the vehicle.

The fixing means 50 and 52 of FIGS. 2 and 4 operate similarly to the wrap around hooks of FIG. 5. The fixing means 56 of FIG. 3 are staples having a semi-circular section which snugly fits around the circular section of the connectors 31. The staples are able to be driven into the vehicle chassis (not shown) for securely fixing the visualisation aid 11 to the vehicle.

The indicators 20, 21, 22, 23 are each positionable forward of a front windscreen of a vehicle (not shown in FIGS. 2 to 5) and in the line of sight of the driver looking at a ground or other surface through the front windscreen of the vehicle.

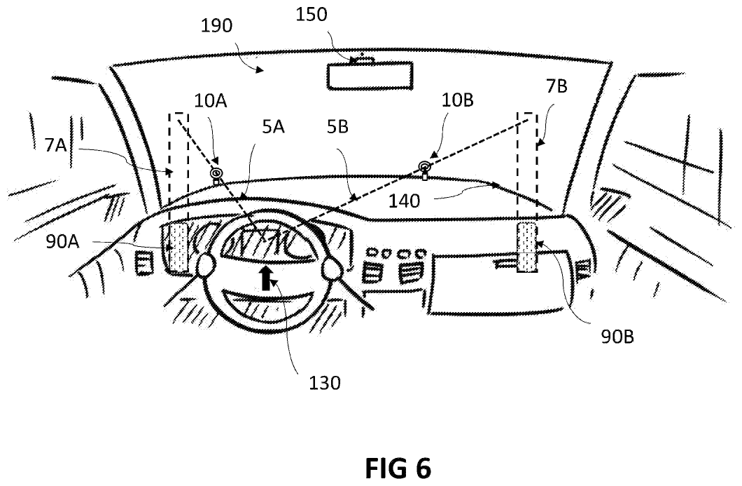

FIGS. 6 to 11 depict visualisation aids as described herein in connection with illustrative but non-limiting preferred embodiments for a particular application (i.e. a car).

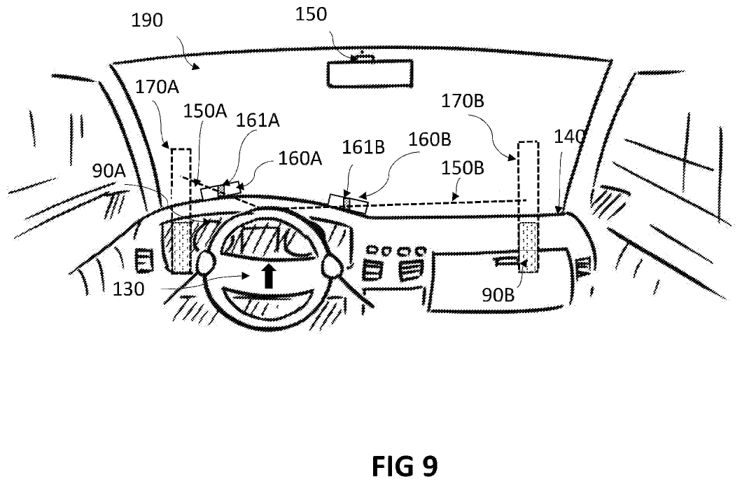

FIG. 6 shows the interior of a vehicle travelling in a straight line (represented by the straight arrow 130). The left and right wheels of the vehicle 90A, 90B are depicted in the location that they would be if they were visible from directly above (i.e. though the components of the vehicle). The indicators 10A and 10B of the visualisations aid are located near the boundary of the vehicle in the driver's lines of sight 5A, 5B that intersect with the vertical planes 7A, 7B extending from wheels 90A, 90B, beyond the boundary of the vehicle 140 (Note: depending on the preferences or characteristics of the driver and/or the form of the vehicle, the boundary of the vehicle 140 visible to the driver may be an interior part of the vehicle, such as the dash board, see FIG. 9).

The indicators 10A, 10B indicate to the driver the projected location of each of the front wheels 90A, 90B respectively on the ground surface (not shown) visible to the driver through the windscreen 190. In particular, the projected location of the front wheels 90A, 90B is the intersection of the respective lines of sight 5A, 5B with the respective vertical planes 7A, 7B.

Indicators 10A and 10B are located frontwards of the windscreen 190 of the vehicle, and in the line of sight of the driver looking out of the front windscreen.

Visualisation aid indicators 10A, 10B are located such that that there is a small gap between the indicators and the boundary 140 defined by the car bonnet, as well as a gap through the central part of the indicators 10A, 10B, through which the ground surface (and in particular the projected wheel location) is visible.

With reference to each of FIGS. 6 to 10, the width of the imaginary vertical planes 7A, 7B, 70A, 70B, 170A, 170B are defined by the width of the front wheels 90A, 90B.

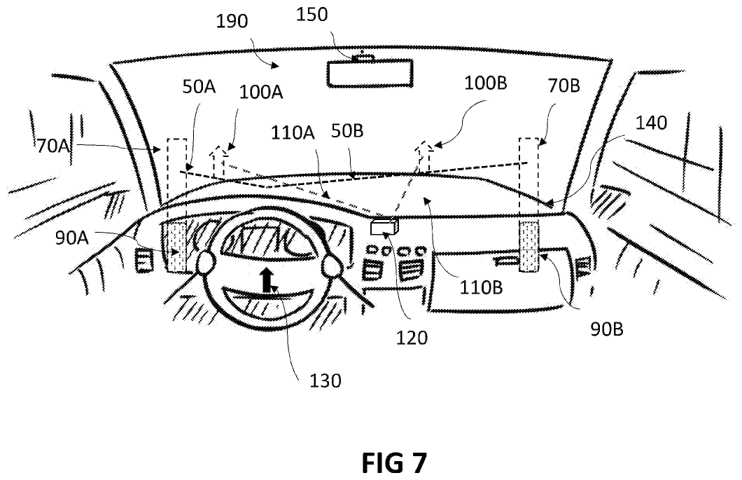

FIG. 7 depicts the interior of a vehicle travelling in a straight line (represented by the straight arrow 130). The left and right wheels of the vehicle 90A, 90B are depicted in the location that they would be if they were visible from above (i.e. though the components of the vehicle). Indicator images 100A and 100B are displayed on the windscreen 190 of the vehicle, and sit in a location which is above the wheels 90A, 90B (i.e. generally higher than, not directly above), and above the boundary of the vehicle 140. The indicators indicate to the driver the projected location of each of the front wheels 90A, 90B respectively on the ground surface (not shown) visible to the driver through the windscreen 190.

The indicators 100A, 100B are respectively positioned in the lines of sight 50A, 50B of the driver looking out of the vehicle at the ground surface (not shown), at and above the boundary 140 of the vehicle in that light of sight. Those parts of the lines of sight 50A, 50B beyond the boundary 140 of the vehicle intersect, respectively, with the imaginary vertical planes 70A, 70B extending forward from the respective front wheels 90A, 90B of the vehicle.

The indicators 100A, 100B are translucent elements having the shape of straight arrows that overlay onto the ground surface the projected wheel path which the vehicle is likely to travel on the basis that the vehicle continues in a straight line (the visualisation aid in this embodiment is responsive to a steering wheel sensor, not shown).

The straight line orientation of the arrows comprising indicators 100A, 100B also indicates to the driver the orientation of the vehicle wheels 90A, 90B.

The indicators 100A, 100B are projected along projection lines 110A, 1108 from the visualisation aid module 120 located on the dashboard of the vehicle. Given the projected images comprising the indicators 100A, 100B are located on the front windscreen 190, their location is more centrally located from the central perspective provided in FIG. 7 than the plane extending from front wheels 90A, 90B. The driver is situated towards the front left of the left-hand drive vehicle depicted in FIG. 7, and so the lines of sight 50A, 50B of the driver looking at the ground surface will accordingly intersect the windscreen 190 in a more central location than they would appear from the driver's perspective (form the driver's perspective they would appear near the intersection of the lines of sight 50A, 50B with the vertical planes 70A, 70B, respectively).

The visually projectable indicator 100B (in particular) is adapted to provide the driver an indication of the projected location of the vehicle 90B wheel that counteracts perspective bias of the driver due to sitting towards the left side of the vehicle.

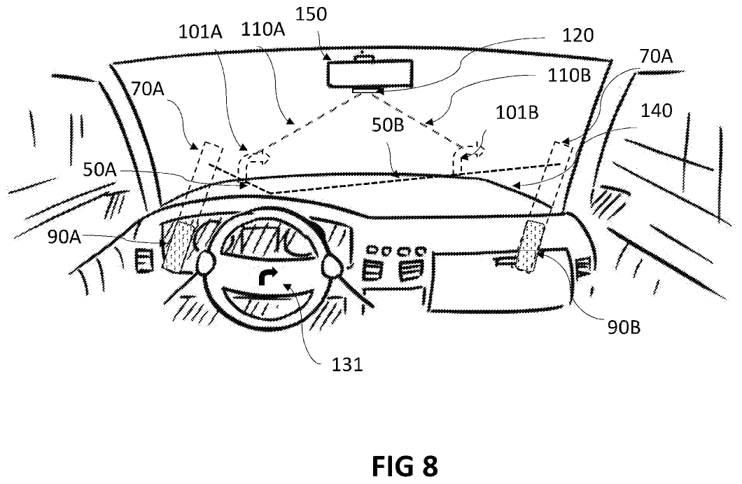

The visualisation aid module 120 provide means for the indicators 100A, 100B to be automatically projected onto or near a target position on the windscreen 190 by applying the following factors to display them at a location that enables indication of the projected vehicle wheel location and wheel travel path to the driver: driver height; the shape and configuration of the boundary of the vehicle that is visible to the driver; driver seat height; angle of inclination of the backrest of the driver seat; driver perspective bias; vehicle dimensions; vehicle wheel size; ground surface inclination; vehicle front wheel orientation; steering wheel orientation; ground surface inclination; other properties of the ground surface; and/or the relative location of the wheel to the driver. Additionally, the location and visual form of the indicators 100A, 100B changes depending on said factors (e.g. the orientation of steering wheel—see FIG. 8).

Turning to FIG. 8, this schematic illustrates the interior of a vehicle turning to the right (represented by the right hand arrow 131). The left and right wheels of the vehicle 90A, 90B are depicted in the location that they would be if they were visible from directly above. Indicators 101A and 101B are displayed on the windscreen of the vehicle, and sit above (i.e. higher than, but not directly above) the wheels 90A, 90B. The indicators 101A, 1018 indicate to the driver the projected location of each of the front wheels 90A, 90B respectively on the ground surface (not shown) visible to the driver through the windscreen 190.

The indicators 101A, 1018 are translucent elements having the shape of right hand arrows that overlay onto the ground surface the projected wheel travel path which is the vehicle is likely to travel on the basis that is continues in a turning direction (note that the shape of the arrows indicating the travel path is exaggerated in FIG. 8 for illustrative purposes, in practice the indicators indicating travel path would include more gradually curved lines).

The indicators 101A, 101B are positioned in the lines of sight 50A, 50B respectively of the driver looking out of the vehicle at the ground surface (not shown), at and above the boundary 140 of the vehicle in that light of sight. Those parts of the lines of sight 50A, 50B beyond the boundary 140 of the vehicle intersect, respectively, with the imaginary vertical planes 70A, 70B extending forward from the respective front wheels 90A, 90B of the vehicle.

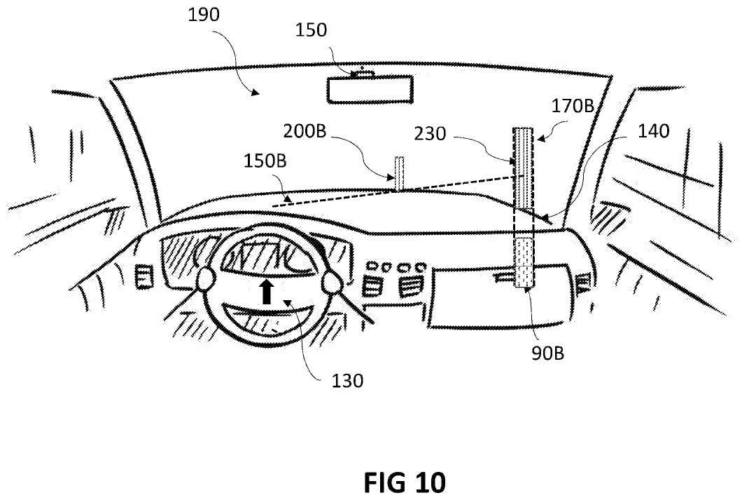

The indicators 101A, 101B are projected along projection lines 110A, 110B from the visualisation aid module 120 (partially visible in FIG. 10), which is connected to the rear vision mirror 150.

The indicators 101A, 101B are adapted to indicate to the driver the projected vehicle wheel path that will be taken if the driver steers the vehicle to perform a turn. The indicators 101A, 101B are adapted to adjust as the steering wheel is turned to assist in the indication of the vehicle wheel path to the driver.

In relation to the implementation of both FIG. 7 and FIG. 8, the location and/or visual form of each of the displayed indicators 100A, 101A, 100B, 101B is adapted to respond to contemporaneous driving parameters including the following: the position of the driver's eyes; vehicle speed or acceleration; the position of the driver's seat; driving conditions; front wheel orientation; properties of the ground surface (e.g. inclination of the ground surface relative to the vehicle); driving conditions (e.g. such the presence or absence of an obstacle on the road or change in uniformity in the driving surface sensed by the visualisation aid); and steering wheel orientation.

The visualisation aid represented in FIGS. 7 and 8 includes the following optional sensors (not shown) for providing sensor data: driver eye location sensor (integrated into the module 120 beside the rear view mirror 150); vehicle speedometer or accelerometer; steering wheel orientation sensor; seat height and/or back rest inclination sensor; a sensor for detecting a hazardous object on the ground or surface; front wheel orientation sensor; and a sensor for detection of a surface or other driving condition for which the visualisation aid is adapted to assist the driver.

The visualisation aid module 120 also includes means for receiving sensor data from the sensors (e.g. for the vehicle speedometer and accelerometer the visualisation aid connects to the vehicle on board diagnostics port using a standardised digital communication method (e.g. applying the OBD-II or EOBD standard) to receive sensor data.

The visualisation aid module 120 includes a processing device for processing sensor data corresponding to contemporaneous driving parameters to determine the movement and/or position of the visually projectable indicator in response to the contemporaneous driving parameters. The visualisation aid is adapted to automatically activate or deactivate visually projectable indicators 100A, 101A, 100B, 101B in response to, or automatically adapt the location and/or visual form of the indicators to, sensed driving conditions.

The visualisation aid module 120 is adapted to be retrofit to an existing vehicle by attachment to the dashboard (see FIG. 7) or rear view mirror 150 (see FIG. 8) of the vehicle. The retrofit visualisation module 120 is removably attachable to the dashboard or rear view mirror 150 of the vehicle.

The visualisation aid illustrated in FIG. 9 comprises display screens 160A, 160B able to be activated to indicate the projected wheel location of each of the front wheels 90A, 90B, respectively, of the vehicle to the driver (not shown). Each display screen 160A, 160B comprises a clear screen impregnated (from the left side of the screen the right side) with LED display indicators, and the specific LED indicators 161A, 161B (shaped in a rectangular approximating that of a wheel) activated on each respective screen indicate the projected wheel location for each front wheel 90A, 90B, respectively. Alternative embodiments of the display or display indicators (not shown) may comprise elements for display on an LCD or other screen.

The display screens 160A, 160B are located on a part of the peripheral (visible boundary) part of dashboard as viewed by the seated driver, such that they are visible to the driver looking frontwards out of the windscreen 190 of the vehicle at a ground surface. The ground surface (not shown) is, in the arrangement depicted in FIG. 9, beyond (and visible by the driver through) the transparent display screens 160A, 160B.

The display indicators 161A, 161B are positioned in the lines of sight 150A, 150B respectively of the driver looking out of the vehicle at the ground surface (not shown), at the boundary 140 of the vehicle in that light of sight. Those parts of the lines of sight 150A, 150B beyond the boundary 140 of the vehicle intersect, respectively, with the imaginary vertical planes 170A, 170B that extend forward from the respective front wheels 90A, 90B of the vehicle, and thereby (i.e. via the arrangement providing said intersection point) indicate the projected wheel location of each respective front wheel.

Each activated display indicator 161A, 161B occupies a target position which is dependent on factors, which can influence how the display indicators are arranged and/or when the display indicator is activated, and influence the size and/or shape of the display indicators, the factors including: driver height, the shape of the external vehicle boundary (or internal boundary such as the dashboard) that is visible to the driver; driver seat height and seat inclination; driver perspective bias; driver eye position; vehicle wheel size and the relative location of the wheel to the driver.

The visualisation aid comprising the display elements 160A, 160B is automatically adjustable (in that the activated display element may change) in response to parameters including the position of the driver's eyes (e.g. where the driver is leaning to the left or to the right); the position of the driver's seat; driving conditions (e.g. the visualisation aid can normally be deactivated and automatically activate only in response to certain driving conditions such as during sensed roadworks or other scenarios where awareness of the front wheel location is more important); and/or steering wheel orientation. The visualisation aid includes sensors to sense one or more of the foregoing parameters, and the sensors include a driver eye location sensor; a steering wheel orientation sensor; a seat height and/or back rest inclination sensor; a sensor for detection of a hazardous object on the ground or surface; a sensor for sensing driving conditions including a surface condition for which the visualisation aid is adapted to assist the driver and (none of which are depicted in the Figures).

The location of the display elements 161A, 161B being in the line of sight of the driver looking at a road surface (just above the external boundary of the dashboard of the vehicle) assists the driver to identify a projected wheel path that the wheel is likely to traverse (as the driver with the assistance of the indicators 161A, 161B is able to more accurately determine the projected location of each front wheel and thereby determine the vehicle wheel path on the road surface), although no projected or additional visual means more directly indicating that path on the road surface itself is provided in this embodiment of the invention (cf. FIG. 10).

FIG. 10 depicts a visualisation aid including an indicator comprising a display 200B that is projected onto the windscreen 190 of the vehicle, where the vehicle is travelling straight ahead (represented by the straight arrow 130). Unlike the embodiment depicted in FIG. 9, the visualisation aid indicates the location of just one front wheel 90B to the driver of the vehicle: the front right wheel, from the perspective of the driver. The display image 200B is displayed using a projector (not shown) hidden from view behind the rear view mirror 150 of the vehicle. The projector comprises a laser that projects focussed light in the form of the display 200B onto the windscreen 190; however, it may alternatively comprise other components commonly applied in heads up display devices which are known to the skilled addressee.

As was the case for FIG. 9, in FIG. 10 the display indicator 200B is positioned in the line of sight 150B of the driver looking out of the vehicle at the ground surface (not shown), at, and extending upwardly from, the boundary 140 of the vehicle in that light of sight. That part of the line of sight 150B beyond the boundary 140 of the vehicle intersects with the imaginary vertical plane 170B that extends forward from the front wheel 90B of the vehicle.

The display image 200B (also referred to as an indicator), being on the inner surface of the windscreen and in (or near) the line of sight between the driver and a ground surface, is directly visible to the driver looking frontwards out of the windscreen 190 of the vehicle at the ground surface. The display image 200B is translucent such that the ground surface may be seen through the display image 200B.

As was the case for the visualisation aid embodiment in depicted in FIG. 9, the display image 200B occupies a target position which is dependent on a number of factors as set out above, where each factor can influence how the projected display is arranged (e.g. the location of the indicator image 200B on the windscreen, depending on driver height or eye position) and/or the form of the projected display. Similarly, the factors can influence the size and/or orientation of the imaginary vertical plane 170B (e.g. plane width changing due to wheel width, and plane orientation changing in accordance with front wheel orientation or steering wheel orientation).

The visualisation aid of FIG. 10 comprising the display image 200B is, in an analogous manner to the display elements of FIG. 9, automatically adjustable in response to parameters set out above regarding the display indicators 161A, 161B (e.g. in the embodiment depicted in FIG. 10, the arrangement and/or form of the display image 200B depends on the steering wheel orientation).

The illustrative non-limiting embodiment of the visualisation aid of FIG. 10 further includes sensors as set out above with respect to FIG. 9 (including for automatic activation or deactivation), and a processor.

The location of the display image 200B being in the line of sight of the road surface of the driver (above the external boundary 140 comprising the bonnet of the vehicle) assists in indicating to the driver the projected wheel path that the wheel 90B is likely to traverse.

The visualisation aid of FIG. 10 is further able to directly indicate to the driver the vehicle wheel path 230 comprising a section of ground or other surface that the vehicle front wheel is likely to traverse: the shape of the indicator image 200B (and consequently the projected wheel path 230) adjusts to the orientation of the steering wheel, among other factors/parameters, such that the driver is provided a dynamically adjusting projected wheel path 230 on the ground surface. The display image 200B is transparent such that the driver is provided a substantially unimpeded view of the ground surface through the indicator 200B, which means the driver can see safely see the road surface through the indicator.

The indicator comprising the projected display image 200B is further adapted to indicate to the driver a change in the orientation of the front wheel 90B by a corresponding change in the orientation of the indicator as viewed by the driver.

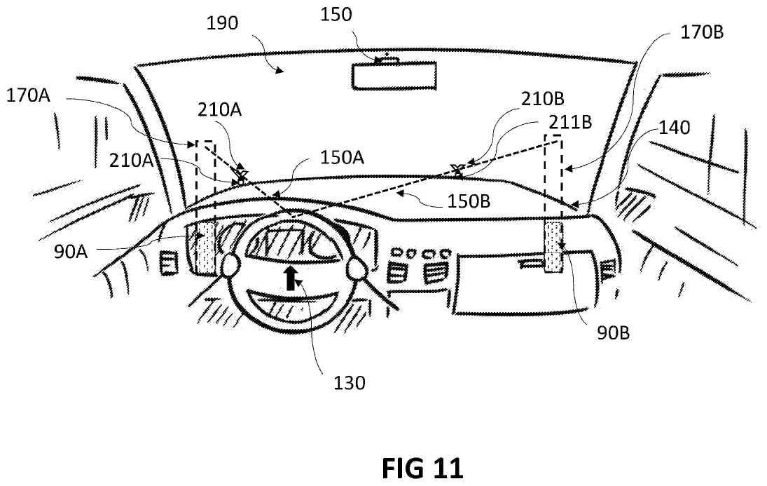

FIG. 11 depicts a further non-limiting embodiment of the invention. The visualisation aid comprises two indicator bodies 210A, 210B, each indicator body comprising a “V” shaped indicator including an open central section through which the ground or other surface is viewable by the driver, the open section being flanked or surrounded by a peripheral portion comprising the “V” shaped element. The visualisation aid further includes collapsible connectors 211A, 211B comprising a thin elongate element (only the upper part of which is shown), connected to a front bar of the vehicle by fixing means (not shown).

The indicator bodies 210A, 210B are positioned forward of the front windscreen 190 of the vehicle, and are able to rotate relative to the vehicle on the vertical axis in which the elongate element of the connector 211A, 211B is positioned. When the connector 211A, 211B is activated, it extends upwardly from the deactivated (collapsed) position to raise the indicator body 210A, 210B to be visible to the driver in a seated position, just above the peripheral part 140 (also referred to as the boundary) of the vehicle that is visible to the driver (i.e. a peripheral part of the front bonnet). In the activated position, the indicator bodies 210A, 210B each indicate the projected wheel location of each of the front wheels 90A, 90B of the vehicle to the driver.

The indicator bodies 210A, 210B are positioned in the lines of sight 150A, 150B respectively of the driver looking out of the vehicle at the ground surface (not shown), at the boundary 140 of the vehicle in that light of sight. Those parts of the lines of sight 150A, 150B beyond the boundary 140 of the vehicle intersect, respectively, with the imaginary vertical planes 170A, 170B that extend forward from the respective front wheels 90A, 90B of the vehicle.

The indicator bodies 210A, 210B are positioned to be directly visible to the seated driver looking frontwards out of the windscreen 190, towards a ground surface located in the line of sight of the driver adjacent to the indicator body. Where the driver is looking frontwards more towards the centre of the windscreen 190, the indicators 210A, 210B remain peripherally visible to the driver, and thereby not distracting to the driver looking frontwards towards the centre of the windscreen. The ground surface (not shown) is, in the arrangement depicted in FIG. 11, beyond the indicator bodies 210A, 210B and visible just around those bodies (the elevated view of the dashboard comprising FIG. 11 makes the front bonnet of the vehicle appear more visible than it would be, in effect, from the perspective of the driver the subject of FIG. 11).

Each activated indicator body 210A, 210B occupies a target position which is dependent on factors such as those listed above, which can influence how the indicator body 210A, 210B is arranged and/or when it is activated, such factors also being able to influence the size and/or orientation imaginary vertical plane 170A, 170B. For example, driver eye position (itself influenced by driver height, or whether the driver is leaning to the left or the right) may change the target position by moving it higher or lower, to the left or to the right.

The visualisation aid including the indicator bodies 210A, 210B is automatically adjustable (in that the body orientation and/or position may change) in response to the parameters referred to above, and in particular those parameters referred to with respect to FIGS. 9 and 10. For example, in response to said parameters, the indicator body 210A, 210B may raise higher or lower (i.e. by extending the collapsible connector higher or lower) or rotate relative to the vehicle (i.e. such that the part of body visible to the driver in an original seated position is maintained during movement of the driver eye position). In a further embodiment (not shown) the visualisation aid may include translation means to translate the position of the connectors 211A, 211B and the bodies 210A, 210B to the left or to the right along the bar (e.g. bulbar) of the vehicle to which the visualisation aid is connected (e.g. the fixing means, not shown, may include rails along which the connectors 211A, 211B may translate to the left or the right, in response to the parameters).

The visualisation aid of the embodiment depicted in FIG. 11 further includes sensors described above in relation to FIGS. 9 and 10.

The position of the indicator bodies 210A, 210B being near to the line of sight of the driver looking at a road surface (just above the external boundary of the bonnet of the vehicle, 140) assists the driver to identify a wheel path that the wheel is likely to traverse. In particular, the driver with the assistance of the indicators 210A, 210B is able to more accurately determine the projected location of each front wheel and thereby extrapolate the vehicle wheel path on the road surface.

The visualisation aid embodiments illustrated in FIGS. 9 to 11 each comprises an indicator (i.e. LED indicators in FIG. 9, display image in FIG. 10, and the indicator bodies in FIG. 11), sensors and a processing device for receiving sensed parameters and to communicate and control the indicator (e.g. to activate or deactivate the indicator, and particularly regarding the indicator display of FIGS. 9 and 10, to change the location or form of the indicator display). The visualisation aids are able to be retrofit to an existing vehicle (e.g. the display screens, projector and/or indicator bodies include wireless communication means for communicating with the processing device adapted for retrofitting, and the processing device and sensors are able to be installed, by providers of aftermarket vehicle accessories and the like, or by the user directly).

### GENERAL STATEMENTS

It will be appreciated by those skilled in the art that many modifications and variations may be made to the embodiments described herein without departing from the spirit and scope of the invention.

It will be understood by the skilled addressee that indicating the projected wheel location comprises indicating the projected wheel location without providing to the driver a view of (e.g. via a mirror or the like), or any vision of (e.g. via a camera or the like), the wheel itself.

Throughout the specification and claims, the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features, that it directly references, but also other components, steps or features not specifically listed, unless the contrary is expressly stated or the context requires otherwise.

In the present specification, terms such as “part”, “component”, “means”, “section”, “segment”, or “module” may refer to singular or plural items and are terms intended to refer to a set of properties, functions or characteristics performed by one or more items having one or more parts. It is envisaged that where a “part”, “component”, “means”, “section”, “segment”, or “module” or similar term is described as consisting of a single item, then a functionally equivalent object consisting of multiple items is considered to fall within the scope of the term; and similarly, where a “part”, “component”, “means”, “section”, “segment”, or “module” or similar term is described as consisting of multiple items, a functionally equivalent object consisting of a single item is considered to fall within the scope of the term. The intended interpretation of such terms described in this paragraph should apply unless the contrary is expressly stated or the context requires otherwise.

The term “connected” or a similar term, should not be interpreted as being limitative to direct connections only. Thus, the scope of the expression a device A connected to a device B should not be limited to devices or systems wherein an output of device A is directly connected to an input of device B. It means that there exists a path between an output of A and an input of B which may be a path including other devices or means. “Connected”, or a similar term, may mean that two or more elements are either in direct physical or electrical contact, or that two or more elements are not in direct contact with each other yet still co-operate or interact with each other.

The dimensions provided in relation to the illustrative visualisation aid are not intended to be prescriptive of all visualisation aids falling within the scope of the invention. The dimensions are provided for illustrative purposes only and should not be construed otherwise.

The mere disclosure of a product element in the specification should not be construed as being essential to the invention claimed herein, except where it is either expressly stated to be so or expressly recited in a claim.

The terms in the claims have the broadest scope of meaning they would have been given by a person of ordinary skill in the art as of the relevant date.

The terms “a” and “an” mean “one or more”, unless expressly specified otherwise.

Neither the title nor any abstract of the present application should be taken as limiting in any way the scope of the claimed invention.

Where the preamble of a claim recites a purpose, benefit or possible use of the claimed invention, it does not limit the claimed invention to having only that purpose, benefit or possible use.

1. A visualisation aid for indicating to a driver of a vehicle a projected location of a front wheel of the vehicle on a ground surface, the visualisation aid including an indicator,
wherein
the indicator is positionable in the line of sight of the driver looking out of the vehicle at the ground surface,
the indicator is positionable adjacent a boundary of the vehicle in the line of sight, and
the line of sight beyond the boundary of the vehicle intersects with an imaginary vertical plane extending forward from the front wheel of the vehicle,
wherein the visualisation aid is adapted to indicate to the driver a projected vehicle wheel path comprising an extended section of ground surface that the vehicle front wheel is likely to traverse, and
wherein indication of the vehicle wheel path is provided by the orientation of the indicator against the ground surface.

2. The visualisation aid according to claim 1, wherein the width of the imaginary vertical plane is defined by the width of the front wheel.

3. The visualisation aid according to claim 1, wherein a target position for the indicator is determined by having reference to one or more, or any combination of, factors including the following:
driver height;
the shape or configuration of the boundary of the vehicle which is visible to the driver;
driver seat height;
angle of inclination of the backrest of the driver seat;
driver perspective bias;
vehicle dimensions;
vehicle wheel size;
vehicle front wheel orientation;
steering wheel orientation;
ground surface inclination;
other properties of the ground surface; and/or
the relative location of the wheel to the driver.

4. The visualisation aid according to claim 3, wherein the visualisation aid includes means for the indicator to be automatically positioned at or close to the target position by applying one or more of the factors to position the indicator.

5. The visualisation aid according to claim 1, wherein the indicator is automatically adjustable in response to contemporaneous driving parameters including any one or more of, or any combination of, the following parameters:
the position of the driver's eyes;
vehicle speed or acceleration;
the position of the driver's seat;
driving conditions;
ground surface inclination;
other properties of the ground surface;
front wheel orientation; and/or
steering wheel orientation.

6. The visualisation aid according to claim 1, wherein the visualisation aid includes one or more of, or a combination of, the following sensors for providing sensor data:
a driver eye location sensor;
a vehicle speedometer or accelerometer;
a steering wheel orientation sensor;
a front wheel orientation sensor;
a seat height and/or back rest inclination sensor; and/or
a sensor for detection of a hazardous object on the ground or surface; and means for receiving sensor data from one or more of, or a combination of the sensors.

7. The visualisation aid according to claim 1, wherein the visualisation aid includes a sensor for sensing driving conditions including properties of the ground surface or other driving conditions for which the visualisation aid is adapted to assist the driver; the visualisation aid further being adapted to be automatically activated or deactivated in response to, or automatically adapt its position and/or visual form to, said sensed driving conditions.

8. The visualisation aid according to claim 1, wherein the indicator is configured such that the driver is able to view the ground surface through and/or around the indicator.

9. The visualisation aid according to claim 1, wherein the indicator is adapted to indicate to the driver a change in an orientation of the front wheel and/or the projected wheel location by a corresponding change in the orientation of the indicator as viewed by the driver.

10. The visualisation aid according to claim 1, wherein the visualisation aid is adapted to indicate to the driver a projected vehicle wheel path comprising an extended section of ground surface that the vehicle front wheel is likely to traverse.

11. The visualisation aid according to claim 1, wherein indication of the vehicle wheel path is provided by enabling the driver to extrapolate the vehicle wheel path based on the orientation of the indicator against the ground surface.

12. The visualisation aid according to claim 1, wherein the visualisation aid is able to be retrofit to an existing vehicle.

13. The visualisation aid according to claim 1, wherein the indicator comprises an indicator body.

14. The visualisation aid according to claim 13, wherein the indicator body is positionable forward of a front windscreen of the vehicle.

15. The visualisation aid according to claim 13, wherein the visualisation aid includes a connector for connecting the indicator body to the vehicle.

16. The visualisation aid according to claim 15, wherein the connector includes a thin elongate element.

17. The visualisation aid according to claim 15, wherein the connector is collapsible.

18. The visualisation aid according to claim 15, wherein the indicator body is movable from an operative position to an inoperative position.

19. The visualisation aid according to claim 18, wherein when the indicator body is in the operative position, the connector is substantially perpendicular to the ground or other surface.

20. The visualisation aid according to claim 15, wherein the connector and/or indicator body is able to rotate, pivot or otherwise move relative to the vehicle.

21. The visualisation aid according to claim 13, wherein the indicator body includes an open central section through which the ground or other surface is viewable by the driver, the open section being flanked or surrounded by a peripheral portion.

22. The visualisation aid according to claim 21, wherein the peripheral portion includes one or more elements consisting of one or more, or any combination of, the following:
a ‘V’ shaped element;
an ‘O’ shaped element;
an arrow shaped element; and/or
a frusto-conical shaped element.

23. The visualisation aid according to claim 21, wherein the peripheral portion is rounded and axially symmetric.

24. The visualisation aid according to claim 1, wherein the indicator comprises an indicator display.

25. The visualisation aid according to claim 24, wherein the indicator display comprises an image on a screen such that the indicator display appears on the screen at or near the intersection of the screen and the line of sight of the driver.

26. The visualisation aid according to claim 24, wherein the indicator display comprises an image on a front windscreen of the vehicle.

27. The visualisation aid according to claim 24, wherein the indicator display comprises an image on a screen that is mountable to the interior of the vehicle.

28. The visualisation aid according to claim 25, wherein a projected vehicle wheel path able to be indicated to the driver by displaying the wheel path on the screen, the displayed wheel path comprising an image indicating an extended section of ground surface that the vehicle front wheel is likely to traverse.

29. The visualisation aid according to claim 24, wherein the indicator display is displayable on or near a dashboard of the vehicle.

30. The visualisation aid according to claim 24, wherein the indicator display, or a part of the indicator display, is translucent.

31. The visualisation aid according to claim 25, wherein the visualisation aid includes an integrated car heads up display unit.

32. The visualisation aid according to claim 1, wherein the projected location of the front wheel is indicated to the driver solely by the position of the indicator.

33. The visualisation aid according to claim 1, wherein the visualisation aid includes a first and a second indicator for indicating to the driver the projected location of a first front wheel of the vehicle, and the projected location of a second front wheel of the vehicle, respectively.
